(19) United States
(12) Patent Application Publication
(10) Pub. No.: US 2014/0022373 A1
(43) Pub. Date: Jan. 23, 2014

(54) CORRELATIVE DRIFT CORRECTION

(71) Applicant: University of Utah Research Foundation, Salt Lake City, UT (US)

(72) Inventors: Stan Kanarowski, Salt Lake City, UT (US); Joerg Bewersdorf, Salt Lake City, UT (US)

(21) Appl. No.: 13/948,035

(22) Filed: Jul. 22, 2013

Related U.S. Application Data
(60) Provisional application No. 61/674,038, filed on Jul. 20, 2012.

(51) Int. Cl. G02B 21/36

(52) U.S. Cl. CPC G02B 21/36
USPC 348/79

(57) ABSTRACT

A correlative drift correction system can include a sample stage for supporting a sample and a cover slip. The system can include an infrared light source for emitting infrared light to be reflected at the cover slip and an optical sensor for detecting the reflected infrared light. The system can detect drift of the sample using reflected infrared light data from the optical sensor and can determine a drift correction to apply to image data of the sample.

### RELATED APPLICATION

This application claims the benefit of U.S. Provisional Application No. 61/674,038, filed Jul. 20, 2012, which is incorporated herein by reference in its entirety.

### FIELD OF THE INVENTION

This invention relates to microscopy. More specifically, the invention relates to super resolution microscopy and the correction of observed sample drift. Therefore, the present invention relates generally to the fields of physics, optics, chemistry and biology.

### BACKGROUND

Diffraction limits spatial resolution to about half of a detected wavelength in far-field light microscopy, such as to a resolution of approximately 250 nm. Super-resolution microscopy can overcome this diffraction limit by taking advantage of fluorescent probe characteristics to exploit stochastic switching probes to achieve resolution values of approximately 20 nm in the lateral direction. Three dimensional variants of super-resolution microscopy can improve axial resolution from approximately 600-800 nm to 30-75 nm in the axial direction, or even down to 10 nm when utilizing two opposing objective lenses.

FPALM (Fluorescence Photoactivation Localization Microscopy) and related technologies (e.g., Photo Activated Localization Microscopy (PALM), Stochastic Optical Reconstruction Microscopy (STORM), and Direct Stochastic Optical Reconstruction Microscopy (dSTORM)) achieve such resolution improvements by stochastically switching probe molecules between fluorescent states that differ either in emission wavelength or amplitude. Imaging parameters often lead to a sparse distribution of fluorescent spots that represent active single molecules in a camera image. The molecule positions are determined by fitting model functions to the intensity distributions and a super-resolution image is compiled from the ensemble of determined molecule positions. Data sets are commonly compiled from a few thousand to more than a million localization events. Since the distribution of molecules in each recorded frame is generally sparse to localize individual molecules reliably, 1,000 to 100,000 camera frames can be recorded over a time frame of from 0.5 seconds up to several minutes.

A drawback to long time measurements is sample or instrument drift caused by temperature changes or mechanical relaxation effects. For example, drift can be in the range of several hundred nanometers over the course of a few minutes. While such drift can be problematic in conventional imaging, even a drift as low as 10 nm can significantly distort images in super-resolution imaging applications.

### SUMMARY

A correlative drift correction system in accordance with one embodiment can include a sample stage for supporting a sample and a cover slip. The system can include an infrared light source for emitting infrared light to be reflected at the cover slip and an optical sensor for detecting the reflected infrared light. The system can detect drift of the sample using reflected infrared light data from the optical sensor and can determine a drift correction to apply to images of the sample.

A correlative drift correction system in accordance with another embodiment can include a sample stage for supporting a sample and a cover slip. The system can include an infrared light source for emitting infrared light to be reflected at the cover slip and an optical sensor for detecting the reflected infrared light. The system can also include an optical observation system for use in observing the sample on the sample stage, a visible light source for illuminating the sample with visible light for observation, and an optical sensor for capturing images of the sample by detecting the visible light. The system can detect drift of the sample using reflected infrared light data from the optical sensor and can apply a drift correction to the images of the sample.

A method for correlative drift correction in accordance with an example can include directing infrared light from an infrared light source toward a sample stage supporting a sample and a cover slip. Infrared light reflected at the cover slip can be detected using an optical sensor. Visible light images of the sample can be captured upon direction of visible light from a visible light source toward the sample stage. Drift of the sample can be detected using reflected infrared light data from the optical sensor and a drift correction can be applied to the visible light images based on the drift.

There has thus been outlined, rather broadly, the more important features of the invention so that the detailed description thereof that follows can be better understood, and so that the present contribution to the art can be better appreciated. Other features of the present invention will become clearer from the following detailed description of the invention, taken with the accompanying drawings and claims, or can be learned by the practice of the invention.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention and they are, therefore, not to be considered limiting of its scope. It will be readily appreciated that the components of the present invention, as generally described and illustrated in the figures herein, could be arranged, sized, and designed in a wide variety of different configurations. Nonetheless, the invention will be described and explained with additional specificity and detail through the use of the accompanying drawings in which:

FIGS. 1a-1d illustrate microscopy systems for correcting drift in accordance with embodiments of the present technology;

FIG. 2 illustrates a process for correlative drift correction in accordance with an embodiment of the present technology;

FIG. 3 is a flow diagram of a correlative drift correction method in accordance with an embodiment of the present technology; and

FIG. 4 is a block diagram of a computing system for correcting drift in accordance with an embodiment of the present technology.

### DETAILED DESCRIPTION

The following detailed description of exemplary embodiments of the invention makes reference to the accompanying drawings, which form a part hereof and in which are shown, by way of illustration, exemplary embodiments in which the invention can be practiced. While these exemplary embodiments are described in sufficient detail to enable those skilled in the art to practice the invention, it should be understood that other embodiments can be realized and that various changes to the invention can be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### DEFINITIONS

In describing and claiming the present invention, the following terminology will be used.

The singular forms “a,” “an,” and “the” include plural referents unless the context clearly dictates otherwise. Thus, for example, reference to “a beam splitter” includes reference to one or more of such devices.

As used herein with respect to an identified property or circumstance, “substantially” refers to a degree of deviation that is sufficiently small so as to not measurably detract from the identified property or circumstance. The exact degree of deviation allowable can in some cases depend on the specific context.

As used herein, the terms “fluorescence” and “luminescence” can be used interchangeably and no distinction is intended or implied unless otherwise explicitly stated as such. Likewise, variants of the terms “fluorescence” and “luminescence”, such as “luminesce” or “fluoresce” are also used synonymously.

As used herein, “proximal” refers to the proximity of two structures or elements. Particularly, elements that are identified as being “proximal” can be in a precise location. Such elements can also be near or close to a location without necessarily being exactly at the location. The exact degree of proximity can in some cases depend on the specific context.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data can be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

In the present disclosure, the term “preferably” or “preferred” is non-exclusive where it is intended to mean “preferably, but not limited to.” Any steps recited in any method or process claims can be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

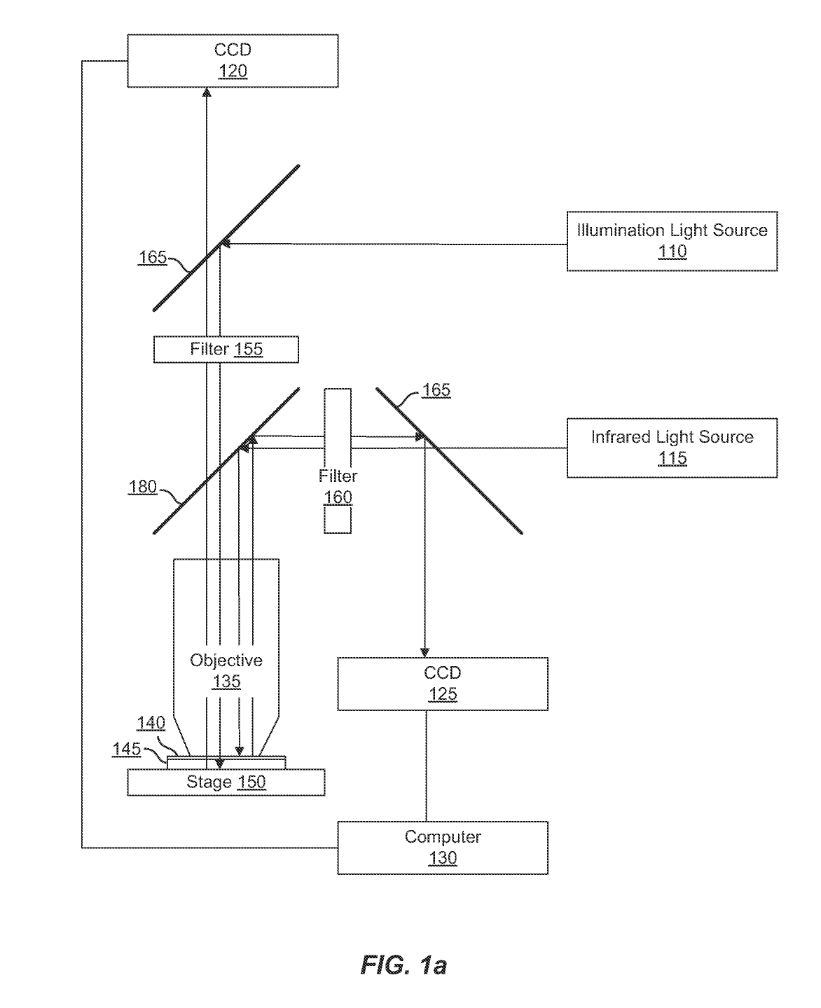

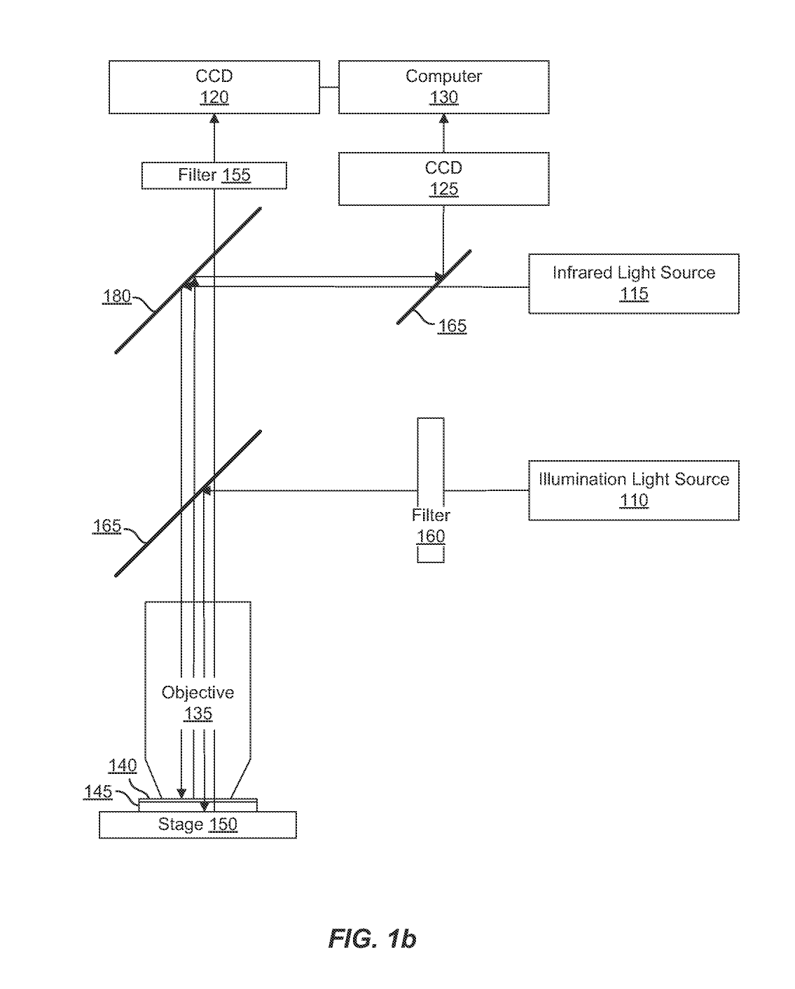

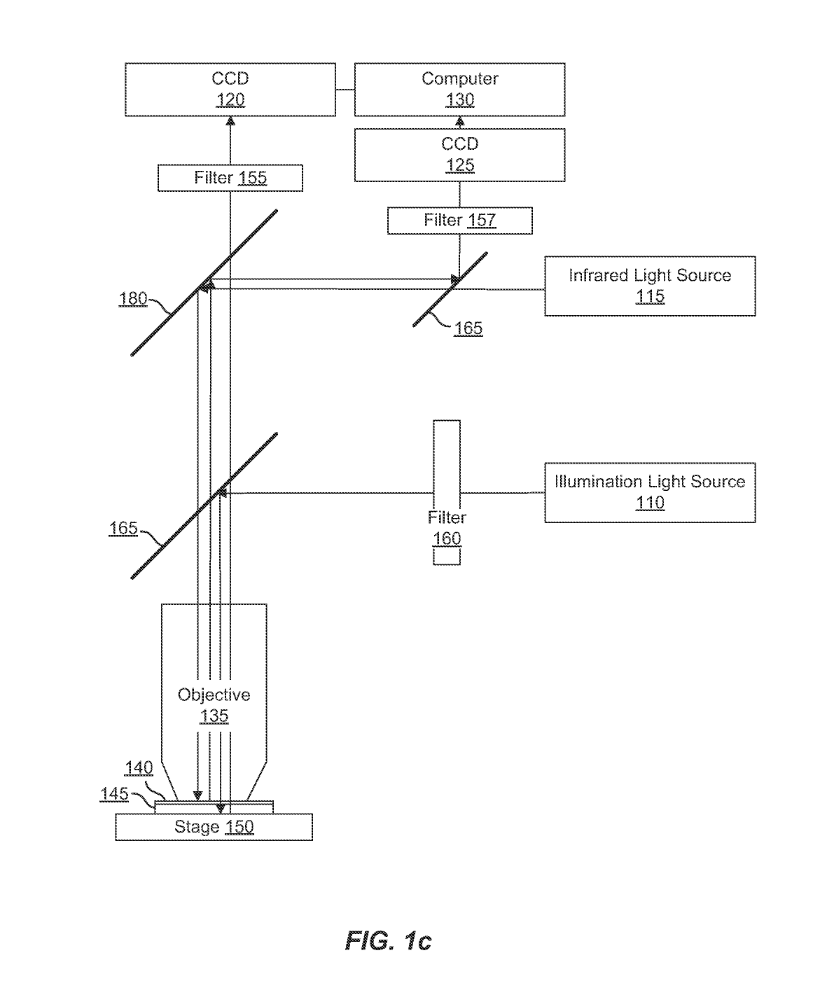

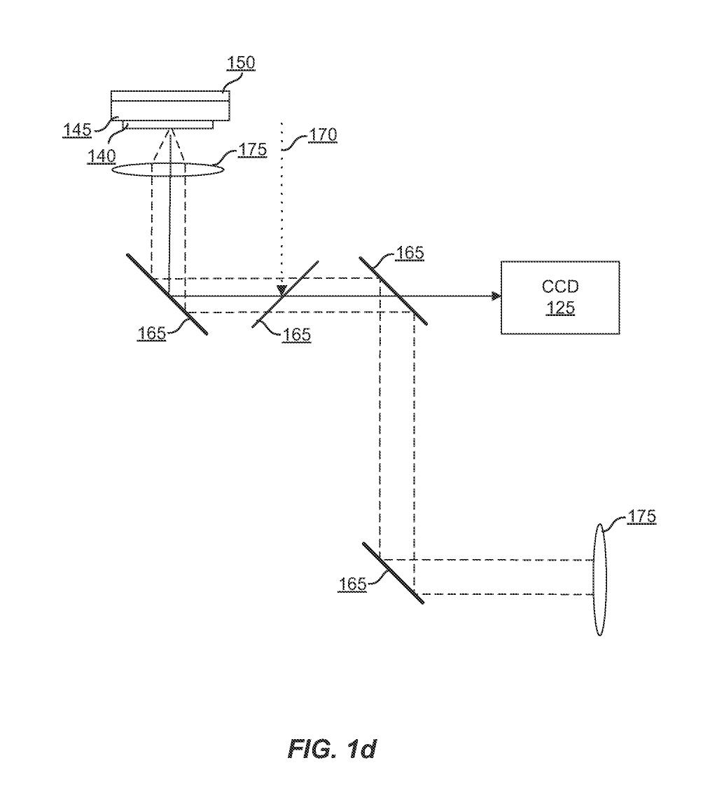

Reference will now be made to FIGS. 1a-4 as will be apparent from the following description.

### Correlative Drift Correction System

Fiduciary markers, such as gold nanoparticles, quantum dots, or fluorescent beads, can be introduced into a sample for drift correction. Fiduciary markers typically do not bleach significantly over the course of recording and can be tracked over a sample observance time. Trajectories of the fiduciary markers can be used to correct for drift of the sample. However, this approach involves introduction of markers into the sample and imaging parameters and instruments need to be adapted to record the markers. Too many markers at wrong locations can interfere with imaging the sample while too few markers can lead to failure of the drift correction. In one example, antibodies labeled by fluorophores and non-specifically bound to the cover slip can be imaged by activating the fluorophores to cause the fluorophores to luminesce. While the fluorophores continue to blink over the course of imaging, repeated activation can enable tracking similar to separately introduced fiduciary markers.

A correlative drift correction system in accordance with an example of the present technology can include a sample stage for supporting a sample and a cover slip. The system can include an infrared light source for emitting infrared light to be reflected at the cover slip and an optical sensor for detecting the reflected infrared light. The system can also include an optical observation system for use in observing the sample on the sample stage, a visible light source for illuminating the sample with visible light for observation, and an optical sensor for capturing images of the sample by detecting the visible light. The system can detect drift of the sample using reflected infrared light data from the optical sensor and can apply a drift correction to the images of the sample.

Referring to FIGS. 1a-1d, systems for correlative drift correction in accordance with various embodiments are illustrated. The systems can generally include a sample stage 150 for supporting a sample 145, a cover slip 140, and an infrared light source 115 for emitting infrared light to be reflected at the cover slip, as well as an optical sensor 130, such as a CCD (charge coupled device) camera for example, for detecting the reflected infrared light. The system can detect drift of the sample using reflected infrared light data from the optical sensor and can determine a drift correction to apply to images of the sample using a computer.

A wide range of dry, water, and oil immersion objectives, such as from 4× to 100× objectives with varying numerical apertures and working distances, can be used with the present technology. An infrared or near-infrared light source 115, such as a laser or LED (Light Emitting Diode), can be used for correlative drift correction. Utilization of an infrared or near-infrared light source can enable use of the system with a large variety of fluorophores emitting in the wavelength range between 340 and 750 nanometers, such as various fluorescent proteins (including near-infrared emitting plant phototropins), quantum dots, and many synthetic fluorophores such as Fura-2, Cy5, Alexa Fluor 700, ATTO dyes, and so forth. The present technology can also be compatible with various contrast-enhancing imaging modes, such as brightfield, darkfield, phase contrast, Hoffman modulation contrast, DIC (differential interference contrast), widefield fluorescence, confocal, TIRF (total internal reflection fluorescence), spinning disk, and line-scanning swept-field microscopy.

The systems can include an illumination light source 110, such as a visible light source, to illuminate the sample. Light from the illumination light source can be reflected and captured using a CCD camera 120 or other imaging device.

The system can include a visible light filter 160 and an infrared filter 155 to filter visible light from an infrared light beam path and to filter infrared light from a visible light beam path. Various optical components 135, 157, 165, 175, 180, 185 can be included in the microscopy system as an optical observation system or subsystem. For example, the optical observation system can include any suitable number, type, and organization of lenses, mirrors, beam-shaping optics, filters, and the like. Some specific examples included in FIGS. 1a-1d include 50-50 beamsplitters, dichroic lenses and the like. The optical observation system can include an objective 135. Some example objectives contemplated for use with the present technology include oil and water immersion objectives, dry objectives, phase contrast objectives, and so forth. In one aspect, water immersion objectives can represent a preferred objective type. Thus, the figures are intended as non-limiting examples of the technology, to which variations can be made or additional system components can be added or subtracted without departing from the scope of the present technology.

The infrared light source 115 and the reflected infrared light data captured by an optical image sensor (e.g., CCD 125 (charge coupled device) or camera) can be used for accurate detection of movement of a sample in x, y, or z reference planes. The infrared light reflects off of the cover slip 140 and is detected by the optical sensor. Thermal drift or vibrations are detected through a movement of the light on the sensor. Software or computer readable instructions processed by a processor in a computing device (i.e., computer 130) can detect and record these movements, which can subsequently be used to correct for drift when localizing images.

The infrared or near-infrared light, which does not interfere with normal transmitted light or fluorescence observation (e.g., light from the illumination light source), can be focused by the objective 135 onto a refractive index boundary that resides between the glass cover slip 140 and the medium surrounding the specimen or sample 145. A refractive index boundary serves as a reference plane when water or oil immersion objectives are used and dry objectives can use an air-glass boundary on the opposite side of the cover slip facing the objective front lens element. After the infrared light is reflected from the glass-water interface the specimen image plane is directed to the optical sensor.

During operation, where a sample stage 150 and/or the sample 145, cover slip 140, etc., shifts in the negative axial (−z) direction, an image (e.g., the reflected infrared light) is shifted along the CCD pixel rows and broadened. The reverse occurs when the sample stage shifts in a positive direction (away from the objective; +z) on the microscope optical axis. Shifts along +/−x or y axes will result in a shift of the image in one direction or another along CCD pixel rows. Occurring shifts in position can be recorded and stored to a correlative drift correction data store for subsequent use in localizing images of the sample.

The present technology can be used, for example, to image living cells housed in imaging chambers equipped with a cover slips of varying thicknesses, such as from 150 to 180 micrometers. Spatial drift of other specimens with weak infrared reflectivity or excessive scattered light can be more difficult to observe.

The one or more CCD cameras 120, 125 of these systems can optionally be an electron multiplying charge coupled device (EMCCD). In a specific example, the camera can be a Sony IX285 CCD. The CCD camera can be a high resolution or high definition camera capable of capturing a minimum of 1024×780 pixels. The IX285 camera provides a resolution of 1392×1040 pixels. In one alternative aspect, the camera system can comprise a plurality of cameras. An optional external liquid cooler can be used to cool the EMCCD. The liquid cooler can use thermoelectric cooling to cool the EMCCD. The EMCCD can include at least two detection channels. The camera can capture images from a transmitted light channel. In one aspect, the transmitted light can be imaged by differential interference contrast. The camera can capture images of one or more molecules at a single instant or as a function of time. The computer 130 can include a particle analysis module in communication with the camera and configured to provide analysis of particle tracking. Fluorophores within a sample can be switched with UV activation. The dyes can be excited to fluoresce by 488 nm or 561 nm light and then bleached.

Referring specifically to FIG. 1a, light from an illumination light source 110 can be used to illuminate a sample 145 on a stage 150 and cause fluorophores to emit fluorescence by switching the fluorophores. Luminescence from the fluorophores can be directed toward a first CCD camera 120 for imaging and can be filtered to filter out different wavelengths of light from reaching the CCD camera. Infrared light from an infrared light source can similarly pass through a filter for filtering out visible light after reflecting off the cover slip 140. After reflecting off the cover slip, the reflected infrared light can be captured by a second CCD camera 125. The infrared light data can be correlated to the visible light data captured by the first CCD camera and can be used to correct drift of the visible light data according to the methods described later.

Referring to FIG. 1b, another example system is illustrated which is similar in many regards to the system of FIG. 1a. In this example, a filter is not included in a beam path for the infrared light and multiple filters are applied to the visible light, including a filter for filtering the visible activation light and a filter for filtering infrared light from the luminescence or fluorescence of the switched fluorophores. Optical component 180 represents a movable dichroic that can be moved or interchanged.

FIG. 1c illustrates another example system which is similar in many regards to the systems of FIGS. 1a-1b and which illustrates a rearrangement of components of such that the second CCD Camera 125 can be used for measuring the distance from the cover slip 140 or can be used for microscopy imaging. The different use cases (i.e., measuring the distance and imaging) can be enabled by moving the motorized dichroic 185. By varying the position of the motorized dichroic mirror 185 the CCD camera 125 can be used to provide different imaging modes such as larger field of view, a faster frame rate, higher sensitivity, and so forth. One of skill in the art will recognize various potential reconfigurations of the system without departing from the scope of the present technology.

FIG. 1d illustrates yet another example configuration of the system with a focus on infrared light, although an activation light beam 170 is illustrated as directed into the system to be reflected toward the sample 145. Specifically, infrared light from an infrared light source can pass through a tube lens or other optic 175 and be redirected toward the cover slip 140, from which the light can be reflected and directed toward a CCD camera 125.

As illustrated in FIGS. 1a-1d, the infrared light source 115 and the visible light source 110 can be positioned to originate two original and different beam paths. A beam manipulation device, such as a mirror, combiner or the like can be used to combine the infrared light and the visible light into a single beam path. A beamsplitter, dichroic lens or the like can be used to subsequently split the infrared light and visible light from the sample into multiple different beam paths, which can be directed to one or more cameras for capturing image or light data. In one example, the multiple different beam paths can be respectively directed parallel to the two original different beam paths. In one example, the multiple different beam paths can respectively include a visible light filter and an infrared filter to filter visible light from an infrared light beam path and to filter infrared light from a visible light beam path. Other optical devices 165 such as half-silvered mirrors, mirrors, lenses, filters and so forth can also be used to direct and manipulate the light to suit a particular application. Other optical devices for focusing or manipulating the light, such as tube lenses and the like may also be included as will be recognized by one of skill in the art.

### Correlative Drift Correction Method

To determine drift in three dimensions, the present technology can utilize 3D (three dimensional) coordinates as well as recording time points of particles of a super-resolution data set. The drift determination and correction technology is compatible with a large number of supermicroscopy systems, including, for example, Biplane FPALM, astigmatism, double-helix, SIM (structured illumination microscopy), spinning disk, SPIM (Sheet plan illumination microscopy) or 4Pi-detection based microscopes.

Drift can be a continuous process, but may not necessarily be linear over the course of measurement. Drift within a single recorded camera frame can be assumed to be negligible. Also, drift in multiple different spatial dimensions may not necessarily be correlated.

As has described above with reference to FIGS. 1a-1d, reflection of the infrared light at the cover slip is detected and captured as an image. Movement and/or variation in the image data is indicative of drift. A same or different image sensor can be substantially simultaneously capturing images of the sample, such as visible light images of the sample.

The method can include sorting the imaged particles into T time intervals of equal length. A value of T can be chosen sufficiently large that drift within each time interval can be assumed to be linear, but small enough to include a sufficiently high number of particles in each interval (typically of the order of 1,000). For each time interval t (0≦t<7), projections of the 3D data in the x, y, and z-direction are performed based on the reflected infrared light data and the particles can be binned into pixels. Each pixel value of the resulting three two-dimensional (2D) images therefore represents the number of localized molecules in a certain volume defined by the pixel size (usually 10 nm×10 nm) and a user-defined depth in direction of the projection. These images are then cross-correlated in 2D with the image of the first time interval t=0. The resulting cross-correlation images (which are twice as large as the correlated images) are then optionally smoothed with a 2D Gaussian blur filter and the maxima of the cross-correlation images are identified. Positions of maxima can be determined from the location of the brightest pixel, which can be, for example, accurate to within ±5 nm. Alternatively, in one example the maxima positions can be determined with sub-pixel precision by fitting a 2D Gaussian peak function to the cross-correlation images. The two coordinates of each maximum describe the overall drift between time interval 0 and t in two directions. From the x, y, or z projections, or rather from the reflected infrared light data on which the projections are based, x, y and z drift coordinates can be determined: x and y-drifts are extracted from the z-projection, and z-drift is determined by averaging over the values determined from the x and y-projections. (x and y-projections are not used to determine y and x-drift, respectively, since in many practical applications these projections do not contain suitable structures that would allow a reliable maximum localization in the x or y-direction). The drift coordinates can then be plotted as a function oft. A cubic spline is optionally fit to the resulting curves to reduce noise. Drift within each time interval is determined by linear interpolation between the drift coordinates obtained for the neighboring time intervals (t−1 and t for particles in the first half of the interval, and t and t+1, for particles in the second half). These drift values are subtracted from the particle coordinates which are then stored as output.

The cross-correlation between the initial time interval t=0 and all subsequent intervals is calculated as described above and smoothed with a 2D Gaussian. To determine the “zero” drift position in the cross-correlation plots, the peak of the autocorrelation function for the t=0 data is used.

The drift of each time interval is determined from the distance between the corresponding cross-correlation peak and the autocorrelation peak. The x and y-drift values are determined from the z-projection cross-correlations and z-drift is determined by averaging the z-values for the x and y-projection cross-correlations. A cubic spline can be fit to each curve to smooth and counter any over or under-corrections, although other curve-fitting and data smoothing techniques can also be used. Drift within each time interval is corrected by linear interpolation using the neighboring time intervals as described above. In practice, determined drift values closely match the actual drift.

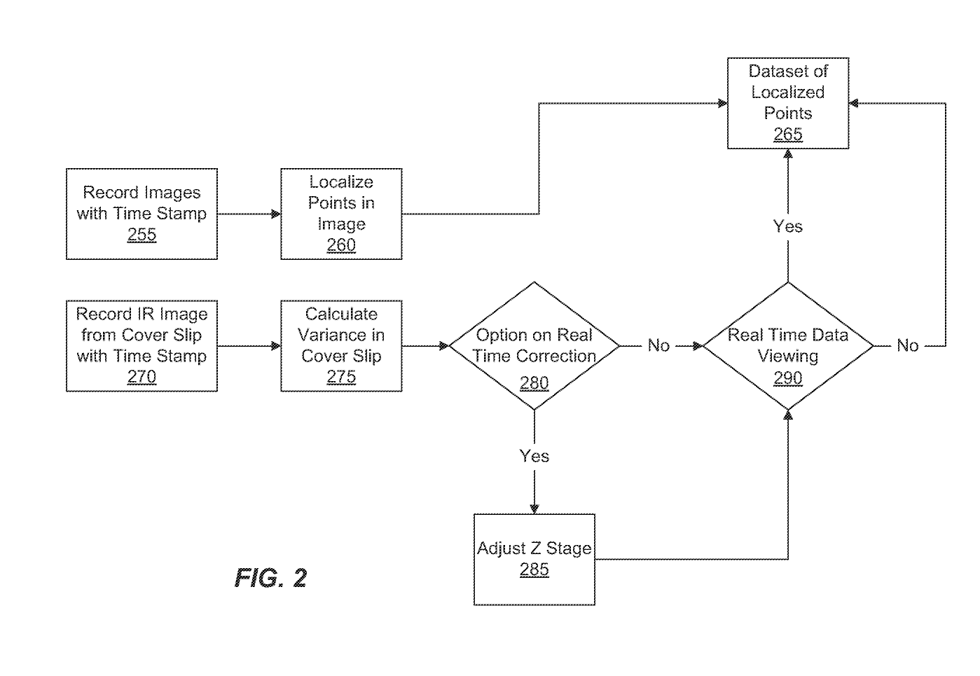

FIG. 2 illustrates an example implementation of the method. Drift correction can be performed entirely in software post-processing of data or can be performed using software post-processing and hardware manipulation, such as in the form of movement of the sample stage in the z direction. In this example, the method includes recording images of the sample 255, localizing points in the image 260, and storing the localized points as a dataset of localized points 265. IR images from the cover slip can be recorded 270 and used to detect drift. In other words, and as illustrated in the drawing, the method includes calculating variance in the cover slip 275, such as by comparing the recorded images to an initial image of the cover slip. As an additional detail illustrated in FIG. 2, the images of the sample or the IR images from the cover slip can be recorded with time stamps to facilitate the correlation between the sample and IR images when correcting for drift.

In the method of FIG. 2, a user can be presented with an option 280 via a graphical user interface displayed on a display device electronically coupled to the processor to view real-time correction for drift. In this example, the correction for drift can include software post-processing as well as mechanical system manipulation. Specifically, the sample stage can be adjusted 285 in the z direction based at least in part on the variance calculated in the cover slip using the recorded IR images. A processor can calculate the variance rapidly and send movement instructions to a motor mechanically coupled to the sample stage for adjusting the sample stage in the z direction to instruct the motor to move the sample stage a distance determined according to the calculated variance. While FIG. 2 illustrates that opting for real time drift correction involves adjustment of the sample stage, the method can also provide real time drift correction via software without adjustment of the sample stage. In other words, software drift correction can be provided by real time processing or can alternatively be provided through post-processing of data.

Whether or not the user selects to correct for drift in real time, the user can select, via the graphical user interface, whether or not to view captured data in real time 290. When the user selects to view the captured data in real time adjustments to the sample stage and/or the image data in dataset of localized points can be made before the data is provided for display to the user. When the user selects not to view the data in real time and/or selects to not perform real time data correction, drift correction can be performed subsequent to recording of the images at any arbitrary time after the recording of the images. In one example, drift correction can be automatically applied to the recorded images after recording of the images is complete. In another example, drift correction can be applied to image data at a predetermined interval after the image data is recorded. In another example, drift correction can be applied in response to a command received from the user, such as to apply drift correction while the user is viewing the recorded data or to apply drift correction in preparation for the user to view the recorded data.

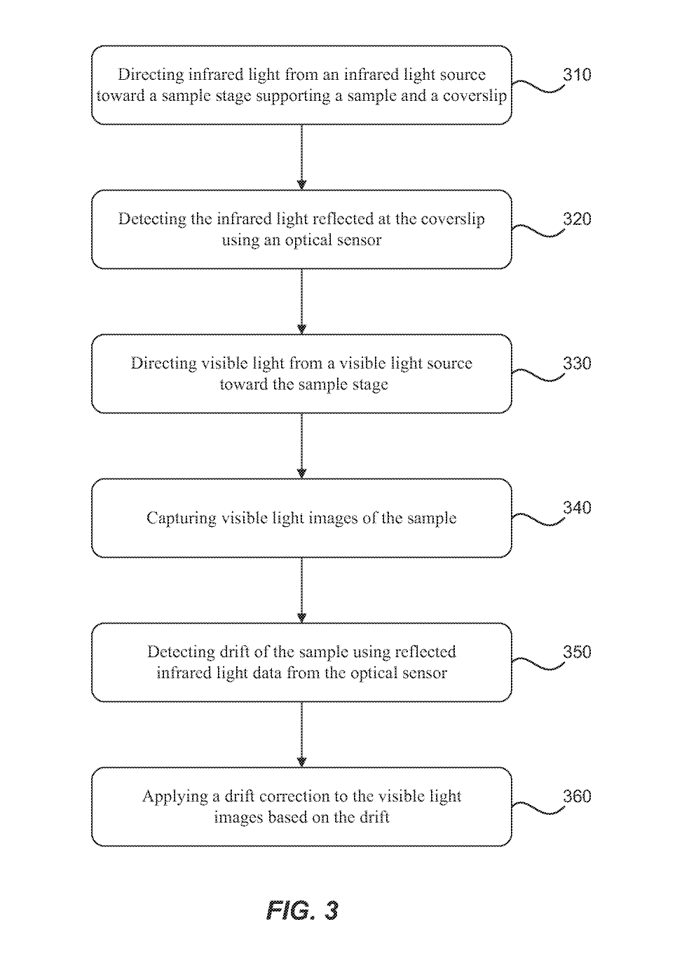

Referring now to FIG. 3, a flow diagram of a method for correlative drift correction is illustrated in accordance with another example of the present technology. The method can include directing 310 infrared light from an infrared light source toward a sample stage supporting a sample and a cover slip Infrared light reflected at the cover slip can be detected 320 using an optical sensor. Visible light images of the sample can be captured upon direction 330 of visible light from a visible light source toward the sample stage. The visible light images can be captured 340 using the same optical sensor as is used for the infrared light reflected from the cover slip or can be captured using a separate optical sensor. In one example, the optical sensors can be different from one another and can be selected based on a desired resolution, quality of recorded images and so forth. For example, a camera for capturing relatively higher quality images or relatively larger images can be used to record images of the sample while a camera for capturing relatively lower quality images or relatively smaller can be used to record infrared images from the cover slip. Drift of the sample can be detected 350 in one, two or three dimensions using reflected infrared light data from the optical sensor and a drift correction can be applied 360 to the visible light images based on the drift. The visible light images can be captured in multiple dimensions as well. For example, the sample stage can be moved in three dimensions. In one aspect, the sample stage can be moved in the z direction (e.g., towards and away from an objective lens) during imaging of the sample to acquire a data stack, or a stack of two-dimensional data slices. As the sample is moved in the z direction, a distance to the sample or the sample stage can be measured from a non-moving point, such as from the objective for example, in order to consider actual drift without inadvertently considering the intentional sample stage movement as drift.

In one aspect, the method can include correcting an optical focus on the sample based on the drift using a focusing module. The focusing module can be software or hardware, or a combination of software and hardware. In one example, correcting the optical focus can be performed by adjusting the sample stage in the z direction, where the focusing module is a motor mechanically coupled to the sample stage. In another aspect, detecting the drift and applying the drift correction can be post-processing steps completed after completion of capturing the visible light images of the sample.

### Example Implementation

Infrared light reflected at the cover slip, such as at an interface between the cover slip and the molecule or at an interface between the cover slip and the objective, can be in any suitable shape, such as a circle, a line, or the like. Movement of the reflected light on the CCD can be used to identify drift. The movement can enable identification of a correlated, adjusted z value for movement in the z direction. The z value can be used in a method to calculate and correct for drift.

Images can be substantially simultaneously captured with a same or different CCD. Drift is corrected for by using the calculated drift from the infrared light data, such as from the z value, and each captured image frame can be localized by comparing the frame to the previous frame. In some examples, background information in an image can be stronger or more dominant than desired image data from the sample. Thus, background image data can be removed from the captured images to more accurately localize the images. Where a reference image can be captured without desired sample data, this reference image can be used in a subtractive manner to remove background data from subsequently captured images with the desired sample data. However, in many examples, such a suitable reference image may be unavailable or unattainable. Background data can be identified by drift or intentional movement of the sample stage in an x,y plane across a z dimension. For example, movement of the stage in an up or down direction can result in a desired object moving among focal planes while other aspects of captured images remain the same. The other aspects of the captured images can be identified as the background data and removed from captured images.

Localization with the present super resolution microscopy technology can enable localization of up to hundreds of thousands of beads, molecules, or the like at a given time based on x, y, z, and time components.

In one aspect, the sample stage can be an electrically activatable or moveable stage, moveable in a z direction, and can enable autofocusing of the stage based on the reflected infrared light. In such case, the technology can still use the reflected infrared light data to localize particles to correct for drift. The present technology provides for correlative drift correction or localization by correlating the infrared light data with images of the sample, and by correlating an individual image of the sample with a previous image of the sample.

The system can also be configured to perform vertical stacks (z-stacks) of image recording, whereby the sample is moved up and down to record different depths. Since the z-stacks are coordinated with the recoding the system can adjust for the change in the sample position, by adjusting for the variance in the distance to the coverslip using the infrared light data from the optical sensor either in real time or in post processing.

Sample drift in super-resolution microscopy has a deleterious effect on a microscope's performance as drift can easily exceed its resolution. The present technology enables compensating for drift in all three dimensions down to a sub-5 nm level for localization-based super-resolution methods. Drift correction can be performed by applying cross-correlations to different, temporally separated, subsets of localized molecules representing the same, fixed, structure based on data obtained by reflecting infrared light at a cover slip covering the molecules.

Certain types of structures can be better suited for drift correction than others. Long filaments oriented in the x-direction, for example, look nearly identical regardless of sample drifts in the x-direction. As a general matter, molecules that are within a distance a from an object “edge” (a structural feature indicating a strong change in density) contribute to detection of drift of magnitude a. This phenomenon is useful to consider when choosing the region of interest (ROI) for the projection included in the present technology.

In practical applications, as demonstrated for diverse samples represented by the simulated structures, the described cross-correlation technology can correct drift of several hundred nanometers to values below 5 nm. This is achieved for typical localization precision values and requires only several hundred to 2,000 localized molecules for each time interval. The method does not involve fiduciary markers and can easily be applied in a wide variety of super-resolution microscopes.

In some situations, it can be useful to image these cells in various environments and in differing conditions. The system described herein can be used for samples which are in vivo, ex vivo, in vitro, perfused, etc. In one alternative aspect, the sample can be incubated in gas. In the case of a gas-incubated sample, the system can further comprise a gas control module configured to control the gas in which the sample is incubated. To better control the sample environment, the system can include a temperature control module configured to control a temperature of the sample and/or a humidity control module configured to control a humidity of the sample.

The system can include a conventional microscope for simultaneous or sequential imaging of the sample. Alternately, or additionally, the system can include an electron microscope configured to acquire electron microscope images of the sample simultaneously or sequentially with the camera. Some examples of contemplated electron microscopes include a scanning electron microscope (SEM) and a transmission electron microscope (TEM). In one exemplary embodiment, the system can be located inside the SEM. The structure of an SEM typically includes a cavity beneath EM. The system herein can be placed or constructed within the SEM cavity. The electron microscope can be configured to display images of the sample simultaneously with image acquisition by the camera.

As described herein, the system can image in vivo, ex vivo or in vitro, molecules, materials, cells, tissues, organisms whether alive or preserved. The system can image these molecules, tissues, etc. where perfusion, temperature, humidity and other environmental conditions need be meet. In one aspect, the system can be used to collect and record information about:

a) PAFMs attached to proteins expressed from an influenza virus;

b) PAFMs attached to lipids;

c) PAFMs attached to the biology of cancer including but not limited to all forms of cancer and nuclear architecture;

d) membrane biology, including but not limited viral uptake and expression at the surface of proteins important to function, cell-cell interaction and disease related defects; and

e) PAFMs attached to the biology of neuroscience and disease, including but not limited to, peripheral neuropathy, Alzheimer's, Multiple Sclerosis, synaptic function, spinal injury and nerve degeneration and regeneration.

Portions of any of the methods described herein can be implemented as computer readable program code executed by the processor, the computer readable code being embodied on a non-transitory computer usable medium.

Systems or devices herein can be include a computing device or computing node that includes hardware processor devices, hardware memory devices, and Input/Output (I/O) devices to enable communication between hardware devices and I/O components. Networking devices can also be provided for communication across a network with other nodes of the technology. The networking device can provide wired or wireless networking access for a mobile device. Examples of wireless access can include cell phone network access, Wi-Fi access, or similar data network access.

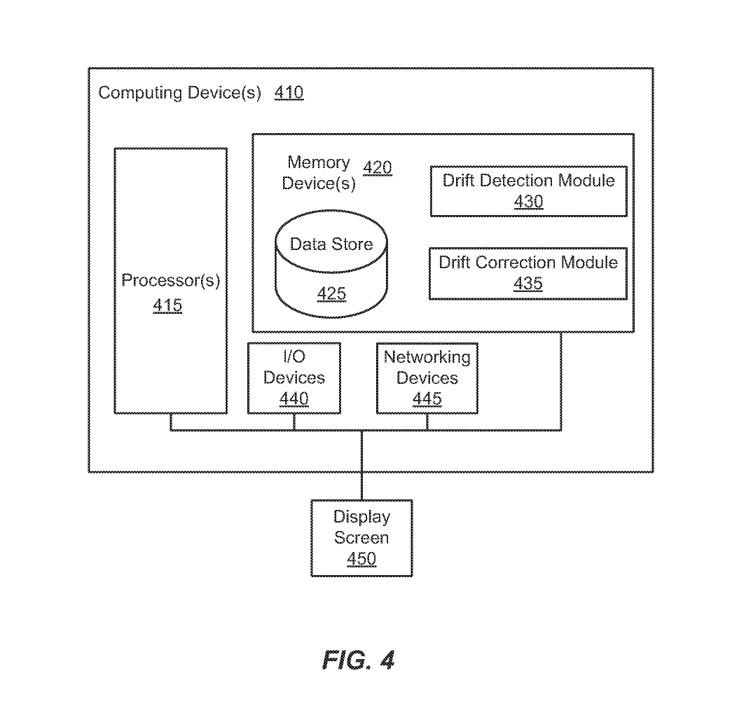

FIG. 4 illustrates a computing device 410 on which modules of this technology can execute. A computing device 410 is illustrated on which a high level example of the technology can be executed. The computing device 410 can include one or more processors 415 that are in communication with memory devices 420. The computing device 410 can include a local communication interface for the components in the computing device. For example, the local communication interface can be a local data bus and/or any related address or control busses as may be desired.

The memory device 420 may contain modules that are executable by the processor(s) and data for the modules. Located in the memory device 420 are modules executable by the processor. For example, a drift detection module 430 and a drift correction module 435, as well as other modules, may be located in the memory device 420. A data store 425 may also be located in the memory device 420 for storing data related to the modules and other applications along with an operating system that is executable by the processor(s) 415.

The computing device 410 may further include or be in communication with a client device, which may include a display device 450 for displaying a user interface or the like. The client device may be available for an administrator to use in interfacing with the computing device 410.

Various applications may be stored in the memory device 420 and may be executable by the processor(s) 415. Components or modules discussed in this description that may be implemented in the form of software using high programming level languages that are compiled, interpreted or executed using a hybrid of the methods.

The computing device 410 may also have access to I/O (input/output) devices 440 that are usable by the computing devices. An example of an I/O device 440 is a display screen that is available to display output from the computing devices. Other known I/O device may be used with the computing device as desired. Networking devices 445 and similar communication devices may be included in the computing device 410. The networking devices 445 may be wired or wireless networking devices 445 that connect to the internet, a LAN, WAN, or other computing network.

The components or modules that are shown as being stored in the memory device 420 may be executed by the processor 415. The term “executable” may mean a program file that is in a form that may be executed by a processor 415. For example, a program in a higher level language may be compiled into machine code in a format that may be loaded into a random access portion of the memory device 420 and executed by the processor 415, or source code may be loaded by another executable program and interpreted to generate instructions in a random access portion of the memory to be executed by a processor 415. The executable program may be stored in any portion or component of the memory device 420. For example, the memory device 420 may be random access memory (RAM), read only memory (ROM), flash memory, a solid state drive, memory card, a hard drive, optical disk, floppy disk, magnetic tape, or any other memory components.

The processor 415 may represent multiple processors and the memory 420 may represent multiple memory units that operate in parallel to the processing circuits. This may provide parallel processing channels for the processes and data in the system. The local interface may be used as a network to facilitate communication between any of the multiple processors and multiple memories. The local interface may use additional systems designed for coordinating communication such as load balancing, bulk data transfer, and similar systems.

While the flowcharts presented for this technology may imply a specific order of execution, the order of execution may differ from what is illustrated. For example, the order of two or more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules in order to more particularly emphasize their implementation independence. For example, a module may be implemented as a hardware circuit comprising custom VLSI (Very Large Scale Integration) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium or computer readable storage device that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Reference has been made to the examples illustrated in the drawings, and specific language has been used herein to describe the same. It will nevertheless be understood that no limitation of the scope of the technology is thereby intended. Alterations and further modifications of the elements illustrated herein, and additional applications of the examples as illustrated herein, which would occur to one skilled in the relevant art and having possession of this disclosure are to be considered within the scope of the description.

With the general examples set forth herein, it is noted that when describing a system, or the related devices or methods, individual or separate descriptions are considered applicable to one another whether or not explicitly discussed in the context of a particular example or embodiment. Furthermore, various modifications and combinations may be derived from the present disclosure and illustrations, and as such, the figures should not be considered limiting.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A correlative drift correction system, comprising:
a sample stage configured to support a sample and a cover slip;
an infrared light source configured to emit infrared light to be reflected at the cover slip;
an optical sensor for detecting the reflected infrared light;
a drift detection module configured to detect drift of the sample using reflected infrared light data from the optical sensor; and
a drift correction module configured to determine a drift correction to apply to image data associated with the sample.

2. The system of claim 1, further comprising:
an optical observation system for use in observing the sample on the sample stage;
a visible light source configured to illuminate the sample with visible light for observation; and
a second optical sensor for detecting the light from the sample as the image data.

3. The system of claim 1, further comprising:
an optical observation system for use in observing the sample on the sample stage; and
a visible light source configured to illuminate the sample with visible light for observation;
wherein the optical sensor is further positioned and configured to detect the light from the sample as the image data.

4. The system of claim 1, further comprising a second optical sensor configured to capture the image data, the drift correction module being further configured to apply the drift correction to the image data.

5. The system of claim 1, wherein the sample stage is moveable in three dimensions.

6. The system of claim 5, whereby the sample stage is moveable in a z direction during imaging to acquire a data stack.

7. The system of claim 1, further comprising a focusing module configured to adjust an optical focus on the sample based on the detected drift.

8. The system of claim 7, further comprising an optical observation system for use in observing the sample on the sample stage, and wherein the optical focus is adjusted by physically moving the sample stage.

9. The system of claim 1, further comprising an objective and a medium between the objective and the cover slip, and wherein the infrared light is reflected at an interface between the cover slip and the medium.

10. A correlative drift correction system, comprising:
a sample stage configured to support a sample and a cover slip;
an optical observation system for use in observing the sample on the sample stage;
a visible light source configured to illuminate the sample with visible light for observation;
an infrared light source configured emit infrared light to be reflected at the cover slip;
a first optical sensor for detecting reflected infrared light data;
a second optical sensor for capturing image data of the sample by detecting the visible light;
a drift detection module configured to detect drift of the sample using the reflected infrared light data; and
a drift correction module configured to determine a drift correction to apply to the image data.

11. The system of claim 10, wherein the infrared light source and the visible light source are positioned to originate two original different beam paths, the system further comprising a beam manipulation device for combining the infrared light and the visible light into a single beam path and for subsequently splitting the infrared light and the visible light into multiple different beam paths.

12. The system of claim 11, wherein the multiple different beam paths are respectively directed parallel to the two original different beam paths.

13. The system of claim 11, wherein the multiple different beam paths respectively include a visible light filter and an infrared filter to filter visible light from an infrared light beam path and to filter infrared light from a visible light beam path.

14. A method for correlative drift correction, comprising:
directing infrared light from an infrared light source toward a sample stage supporting a sample and a cover slip;
detecting the infrared light reflected at the cover slip using an optical sensor;
directing visible light from a visible light source toward the sample stage;
capturing visible light image data of the sample;
detecting drift of the sample using reflected infrared light data from the optical sensor; and
applying a drift correction to the visible light image data based on the drift.

15. The method of claim 14, further comprising correcting an optical focus on the sample based on the drift.

16. The method of claim 14, wherein detecting the drift comprises detecting the drift in three dimensions.

17. The method of claim 14, wherein the steps of detecting the drift and applying the drift correction are post-processing steps completed after completion of capturing the visible light image data of the sample.

18. The method of claim 14, wherein capturing the visible light image data of the sample comprises capturing the visible light image data of the sample using the optical sensor.

19. The method of claim 14, wherein capturing the visible light image data of the sample comprises capturing the visible light image data of the sample using a second optical sensor.

20. The method of claim 14, further comprising moving the sample stage in a z direction while capturing the visible light image data of the sample to acquire a data stack.
